(19) United States
(12) Patent Application Publication
(10) Pub. No.: US 2002/0094839 A1
(43) Pub. Date: Jul. 18, 2002

(54) Portable telephone set

(76) Inventor: Satoshi Otsuka, Kanagawa (JP)

Correspondence Address: Michael Best & Friedrich LLC, 401 North Michigan Avenue, Chicago, IL, 60611, US

(21) Appl. No.: 10/044,059

(22) Filed: Jan. 11, 2002

(30) Foreign Application Priority Data
Jan. 12, 2001 (JP) 005470/2001

(51) Int. Cl. H04M 1/00

(52) U.S. Cl. 455/556; 455/566; 455/412

(57) ABSTRACT

A portable telephone set having an additional function unit as well as communication function unit includes stopping means 106 for stopping the operation of communication function unit. In response to the stopping operation of communication function unit 110, the portable telephone set 1 is repeatedly operative for a predetermined time for checking presence of the arrival call and/or mail to its own telephone set and displaying the arrival call and/or mail and/or a telephone number for the arrival call and/or an address for the mail.

### BACKGROUND OF THE INVENTION

This application claims benefit of Japanese Patent Application No. 2001-005470 filed on Jan. 12, 2001, the contents of which are incorporated by the reference.

The present invention relates to portable telephone sets and, more particularly, to portable telephone sets having additional functions such as game functions and music reproducing functions as well as the telephone functions.

In the prior art portable telephone set having additional functions such as game functions and music reproducing functions as well as telephone functions, all the functions are stopped by turning off the power supply. Therefore, it has been impossible to use the set by stopping only the telephone functions and having only the additional functions effective.

In the prior art portable telephone set, therefore, a call arrival always produces an interruption even while a game, a mail production, etc. is enjoyed by starting application software among the game functions. The interruption when produced disables the concentration on a game, for instance.

### SUMMARY OF THE INVENTION

The present invention was made in view of the above background, and it has an object of providing a portable telephone set capable of prohibiting the interruption by a call arrival while an additional function such as a game function is in use, thus permitting concentration on the use of this additional function.

According to an aspect of the present invention, there is provided a portable telephone set having additional functions such as game functions as well as telephone functions, wherein the additional functions other than the telephone functions are operated by stopping the operation of the telephone functions.

According to another aspect of the present invention, there is provided portable telephone set having additional functions such as game functions as well as telephone functions, comprising: a manipulating means with a telephone function stop key for stopping the telephone functions; a radio communicating means for performing communication with the outside; and a control means for stopping the function of the radio communicating means when the telephone function stop key in the manipulating means is manipulated.

The portable telephone set further comprises a display means for displaying various data, and in which the control means is operative to render the radio communicating means operative when a predetermined time has passed after the stopping of the function of the radio communicating means, then check whether a mail addressed to the own station is present in the network, and in the case of the presence of a mail addressed to the self station, display a mail ICON indicative of the presence of the mail addressed to the own station on the display means.

According to other aspect of the present invention, there is provided a portable telephone set having an additional function unit as well as communication function unit, the telephone set including stopping means for stopping the operation of communication function unit and in response to the stopping operation of communication function unit being repeatedly operative for a predetermined time for checking presence of the arrival call and/or mail to its own telephone set and displaying the arrival call and/or mail. A telephone number for the arrival call and/or an address for the mail are displayed. The stopping means stops power supply to the communication function unit.

Other objects and features will be clarified from the following description with reference to attached drawings.

### BRIEF DESCRIPTION OF THE DRAWINGS

FIG. 1 shows the construction of a communication system incorporating an embodiment of the portable telephone set according to the present invention;

FIG. 2 shows the construction of the embodiment of the portable telephone set according to the present invention;

FIG. 3 is a flow chart illustrating the routine executed in the case when the telephone function stop key of the manipulating unit 106 is manipulated; and

FIG. 4 is a flow chart illustrating the timer interruption processing routine.

### PREFERRED EMBODIMENTS OF THE INVENTION

Preferred embodiments of the present invention will now be described with reference to the drawings.

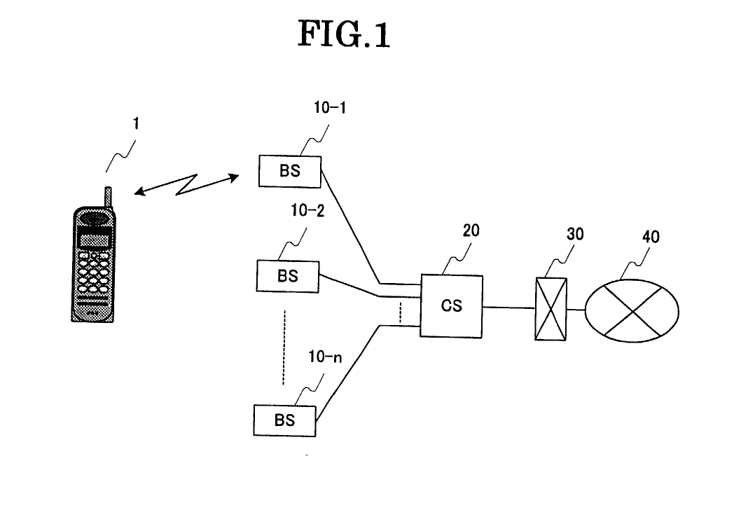

FIG. 1 shows the construction of a communication system incorporating an embodiment of the portable telephone set according to the present invention. This communication system comprises a portable telephone set 1 as a mobile station, a plurality of base stations 10-1, 10-2, . . . , 10-n and a control station 20 for collectively controlling the base stations 10-1, 10-2, . . . , 10-n. The control station 20 is connected via a switching unit 30 to a stationary communication network 40.

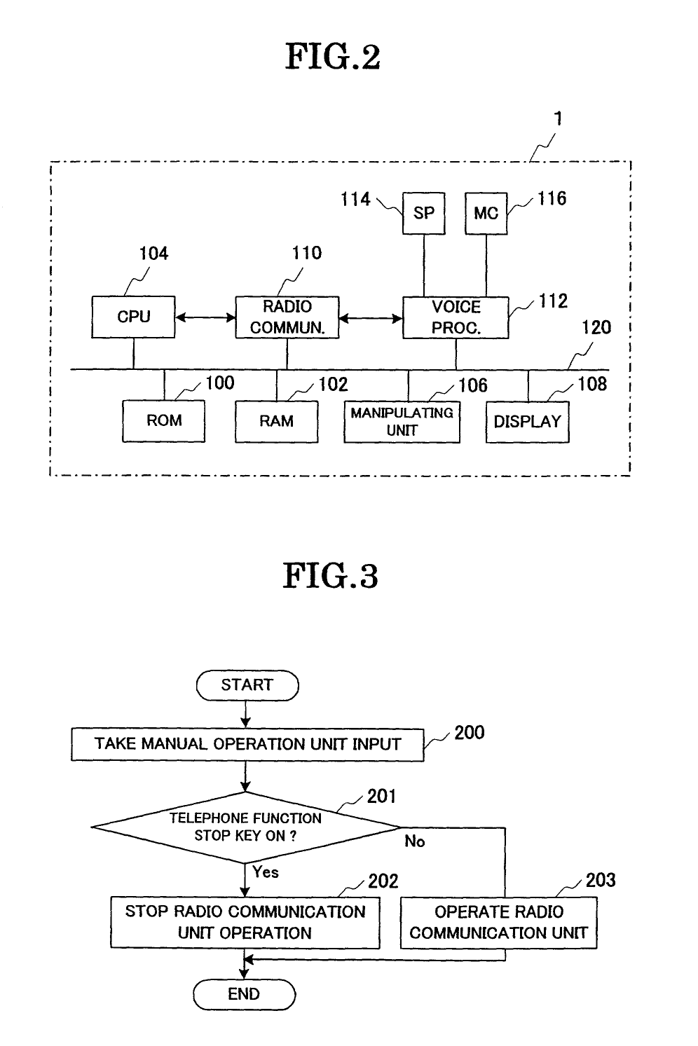

FIG. 2 shows the construction of the embodiment of the portable telephone set according to the present invention. Referring to the Figure, the portable telephone set 1 comprises a ROM 100, in which various programs and fixed data are stored, a RAM 102, a CPU 104, which realize various additional functions such as game function and music reproducing function as well as the telephone function by executing various programs stored in the ROM 100, a manipulation unit 106, a display unit 108 and a radio communication unit 110, a voice processing unit 112, a loud-speaker 114 and a microphone 116. The ROM 100, the RAM 102, the CPU 104, the manipulating unit 106, the display unit 108, the radio communication unit 110 and the voice processing unit 112 are interconnected via a bus 120.

The manipulating unit 106 has a telephone function stop key for stopping the telephone function. The CPU 104 provides such control as to stop the function of the radio communication unit 110 in response to the manipulation of the telephone function stop key. By the term “CPU 104 provides such control as to stop the function of the radio communication unit 110” is specifically meant that the CPU 101 provides such control as to stop processing in the radio communication unit 100. It is also possible to provide such control as to stop power supply to the radio communication unit 110.

The radio communication unit 110 modulates the voice signal outputted from the voice processing unit 112, and outputs the modulated signal via an antenna (not shown) to the outside. The unit 110 also demodulates the signal inputted via the antenna thereto, and outputs the demodulated the signal to the voice processing unit 112.

The voice processing unit 112 is constituted by a voice CODEC or the like, and it functions to D/A convert the voice signal outputted from the radio communication unit 110 and output the converted voice signal to the loud-speaker 114. The voice processing unit 112 further functions to A/D convert the voice signal inputted from the microphone 116 and output the converted voice signal to the radio communication unit 110. The display unit 108 functions such that when a mail has been received in the portable telephone set 1, it displays a mail ICON indicative of the presence of the received mail.

The CPU 104, the manipulating unit 106 and the radio communication unit 110 correspond to a control means, a manipulating means a display means and a radio communication means, respectively in the present invention.

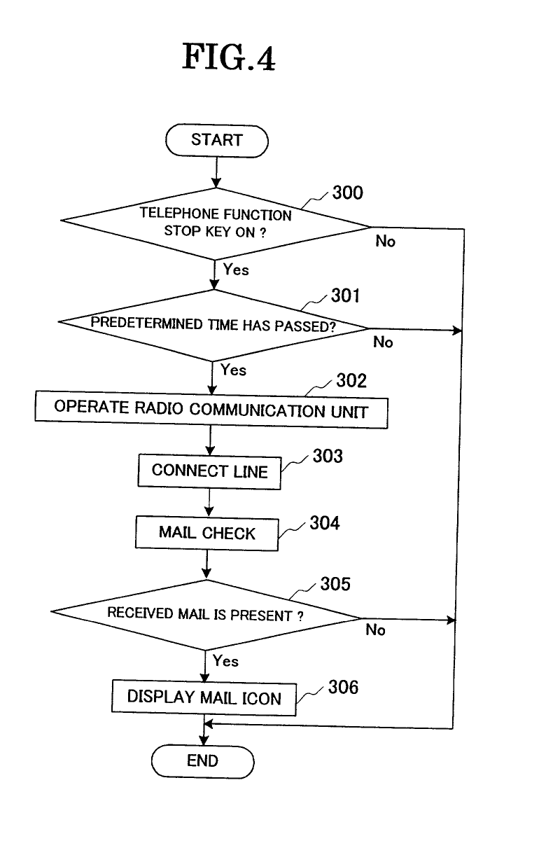

The operation of the portable telephone set 1 will be described with reference to the flow charts of FIGS. 3 and 4. FIG. 3 illustrates the routine executed in the case when the telephone function stop key of the manipulating unit 106 is manipulated. Referring to the Figure, an input signal from the manipulating unit 106 is taken (Step 200). A check is then performed as to whether the telephone function stop key in the manipulating unit 106 has been manipulated (Step 201). When it is determined in the step 201 that the telephone function stop key has been manipulated, the function of the radio communication unit 110, i.e., the operation thereof is stopped (Step 202), thus bringing an end to this routine.

In this state, it is possible to use the additional functions such as game functions of the set. In this case, when the user is enjoying a game by using the game function, no interruption is produced by a call arrival.

When it is determined in the step 201 that the telephone function stop key has not been manipulated, a waiting state is brought about by rendering the ratio communication unit 110 operative (Step 203)), thus bringing an end to this routine.

FIG. 4 illustrates the timer interruption processing routine, which is started in a constant cycle when the telephone function has been stopped. Referring to the Figure, in step 300 a check is performed as to whether the telephone function stop key in the manipulating unit 106 has been manipulated. When the telephone function stop key has not been manipulated, an end is brought to this routine. When the telephone function stop key has been manipulated, a check is performed as to whether a constant time has passed after the manipulation of the telephone function stop key (Step 301). When it is determined in the step 301 that the constant time has not yet been passed, an end is brought to this routine.

When it is determined in the step 301 that the constant time has passed after the operation of the telephone function stop key, the radio communication unit 110 is rendered operative, then a circuit is connected with the base station in charge of the area, in which the own station is present, for instance the base station 10-1 (see FIG. 1), and finally a circuit is connected between the portable telephone set 1 and a main server (not shown) managed by the control station 20 (Steps 302 and 303).

Subsequently, the mail server checks whether any main addressed to the portable telephone set 1 is present, and the result is informed to the portable telephone set 1 (Step 304). The portable telephone set 1 makes a check as to whether any received mail is present by checking the informed content (Step 305). When no received mail is present, an end is brought to this routine. When it is determined in the step 305 that a received mail is present, a mail ICON indicative of the presence of the received mail is displayed in the display unit 108, thus bringing an end to this routine.

By adding a user's pass word input to the on/off operation of the telephone function stop switch, the user, once turning on the switch, becomes free from unfair use of the set for communication by any other person. It is thus possible to prevent reception of an enormous free charge due to unfair use of the set by an unknown person.

As has been described in the foregoing, in the embodiment of the portable telephone set according to the present invention the telephone function stop switch is held “on” when it is not desired that a game played with the set is interrupted by a call arrival or the like. By so doing the game can be continued without being interrupted by any call arrival or the like. Besides, during such time it is possible to save consumed power.

In the portable telephone set having an additional function unit as well as communication function unit may includes stopping means for stopping the operation of communication function unit. In response to the stopping operation of communication function unit, the portable telephone set is repeatedly operative for a predetermined time for checking presence of the arrival call and/or mail to its own telephone set and displaying the arrival call and/or mail. A telephone number for the arrival call and/or an address for the mail may be displayed.

In another aspect, in an airplane or like place where the portable telephone set can not be used due to the influence of electromagnetic waves, the power supply should be held “off”. With the power supply held “off”, the time check can not be made when desired.

With the telephone function stop switch held “on”, the operation in the radio communication unit is “off”, and the portable telephone set is free form any influence of electromagnetic waves. Thus, it is possible to hold the power supply “on” and make time checks.

Furthermore, when tests in the development of system, particularly a test free from any communication (such as a test of the manipulating unit) are performed with the telephone function stop switch held “off”, no wasteful operation in the radio communication unit is executed. Thus, the battery life can be extended, and it is possible to reduce the battery charging time.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A portable telephone set having additional functions such as game functions as well as telephone functions, wherein the additional functions other than the telephone functions are operated by stopping the operation of the telephone functions.

2. A portable telephone set having additional functions such as game functions as well as telephone functions, comprising:
a manipulating means with a telephone function stop key for stopping the telephone functions;
a radio communicating means for performing communication with the outside; and
a control means for stopping the function of the radio communicating means when the telephone function stop key in the manipulating means is manipulated.

3. The portable telephone set according to claim 1 or 2, which further comprises a display means for displaying various data, and in which:
the control means is operative to render the radio communicating means operative when a predetermined time has passed after the stopping of the function of the radio communicating means, then check whether a mail addressed to the own station is present in the network, and in the case of the presence of a mail addressed to the self station, display a mail ICON indicative of the presence of the mail addressed to the own station on the display means.

4. A portable telephone set having an additional function unit as well as communication function unit, the telephone set including stopping means for stopping the operation of communication function unit and in response to the stopping operation of communication function unit being repeatedly operative for a predetermined time for checking presence of the arrival call and/or mail to its own telephone set and displaying the arrival call and/or mail.

5. The portable telephone set according to claim 4, wherein a telephone number for the arrival call and/or an address for the mail are displayed.

6. The portable telephone set according to claim 4, wherein the stopping means stops power supply to the communication function unit.
